(19) United States
(12) Patent Application Publication
(10) Pub. No.: US 2024/0044010 A1
(43) Pub. Date: Feb. 8, 2024

(54) CHEMICAL SURFACE TREATMENT METHOD OF METAL FOR BONDING MATERIALS

(71) Applicants: HYUNDAI MOTOR COMPANY, Seoul (KR); KIA CORPORATION, Seoul (KR); IL KWANG POLYMER. CO., LTD, Hwaseong-si (KR)

(72) Inventors: Jae Gi Sim, Seoul (KR); Myung Ju Lee, Goyang-si (KR)

(73) Assignees: HYUNDAI MOTOR COMPANY, Seoul (KR); KIA CORPORATION, Seoul (KR); IL KWANG POLYMER. CO., LTD, Hwaseong-si (KR)

(21) Appl. No.: 18/100,423

(22) Filed: Jan. 23, 2023

(30) Foreign Application Priority Data
Aug. 8, 2022 (KR) 10-2022-0098651

(51) Int. Cl. C23C 22/77; C23C 22/82; C23C 22/68; C23C 22/06

(52) U.S. Cl. CPC C23C 22/77; C23C 22/82; C23C 22/68; C23C 22/06

(57) ABSTRACT

A chemical surface treatment method of a metal improves bonding of different materials in which first pores are formed in the surface of the metal and second pores are formed locally in the surfaces of the first pores by appropriately setting the number of repetitions of alkali treatment and acid treatment, the concentrations of treatment solutions, and treatment temperatures and times using the treatment solutions. The method includes performing the alkali treatment by immersing the metal in a base solution, so as to form first pores in a surface of the metal. The method further includes performing the acid treatment by immersing an alkali-treated result product in an acid solution, so as to form second pores locally in surfaces of the first pores.

### CROSS-REFERENCE TO RELATED APPLICATION

This application claims under 35 U.S.C. § 119(a) the benefit of priority to Korean Patent Application No. 10-2022-0098651 filed on Aug. 8, 2022, the entire contents of which are incorporated herein by reference.

### BACKGROUND

### (a) Technical Field

The present disclosure relates to a chemical surface treatment method of a metal for improved bonding different materials in which first pores are formed in the surface of the metal and second pores are formed locally in the surfaces of the first pores by appropriately setting the number of repetitions of alkali treatment and acid treatment, the concentrations of treatment solutions, and treatment temperatures and times using the treatment solutions.

### (b) Background Art

Metal insert plastic injection molding, which is one of the processes of bonding different materials, produces many hybrid structures by providing mechanical binding force using a design method without surface treatment of a metal. Different materials, (e.g., the metal and plastic), have no bonding characteristics on the bonding surface therebetween. Thus, the metal insert plastic injection molding method has a limit in application to vehicle parts requiring high durability.

Therefore, in order to solve such a problem, surface treatment methods, such as laser surface treatment, anodizing surface treatment, or bonding solution immersion, have conventionally been proposed.

In a method of bonding different materials using an adhesive, molding using aluminum and molding using plastic are respectively performed. Then the acquired molded products are bonded by the adhesive, or the adhesive is applied between aluminum and plastic and then injection molding is performed. The above method of bonding different materials using the adhesive requires a long cycle time and at least two molds in the case in which the molded products are bonded by the adhesive and is thus ineffective and is limited in terms of properties. Further, in the case in which the adhesive is applied between aluminum and plastic and then injection molding is performed, adhesives that exhibit performance at a high temperature are rare, and the material of the adhesive may be swept away to a specific region when molten plastic flows.

In a method of bonding different materials using laser processing, a specific pattern is formed in the surface of a metal by radiating laser light thereon. Through laser radiation, it is difficult to form undercut shapes due to straightness of light, and the properties of a metal material, to which the laser light is radiated, may be degraded due to thermal softening. Particularly, it is very difficult to uniformly radiate laser light to the metal material having a complicated shape. Thus, the method of bonding different materials using laser processing is limited to plate members, rod members, etc.

Therefore, attempts to chemically treat the surface of a metal so as to simply regulate line roughness, or to add a specific chemical substance during etching so as to increase bonding force with plastic have conventionally been made. However, in the above chemical surface treatment methods, specific parts of a metal structure are etched and thus etching is not uniform. Also, an etching depth is low and thus bonding force is limited and, therefore, a process of improving the bonding force by additional use of general anodization is added. Thus, all processes are complicated and synergy between etching and anodization is of little effect.

Therefore, the above-described conventional methods of bonding different materials respectively have limiting factors and are thus limited in industrialization of vehicle parts.

The above information disclosed in this Background section is only to enhance understanding of the background of the disclosure. Therefore, the Background section may contain information that does not form the prior art that is already known to a person of ordinary skill in the art.

### SUMMARY OF THE DISCLOSURE

In view of the foregoing, for the above-described reasons, development of a chemical surface treatment method of a metal for improved bonding of different materials, in which parts formed of various materials may be bonded so as to reduce the costs of vehicle parts, is required.

The present disclosure has been made in an effort to solve the above-described problems associated with the prior art. It is an object of the present disclosure to provide a chemical surface treatment method of a metal for improved bonding of different materials in which parts formed of various materials may be bonded so as to achieve weight lightening and cost reduction of vehicle parts.

In one aspect, the present disclosure provides a chemical surface treatment method of a metal for improved bonding between different materials. The method includes performing alkali treatment by immersing the metal in a base solution so as to form first pores in a surface of the metal and includes performing acid treatment by immersing an alkali-treated result product in an acid solution so as to form second pores locally in surfaces of the first pores.

In an embodiment, the chemical surface treatment method may further include repeating the alkali treatment and the acid treatment 2 to 5 times, after the performing the initial acid treatment.

In another embodiment, the first pores may be micro-sized pores and the second pores may be nano-sized pores.

In still another embodiment, the metal may include aluminum alloys, magnesium alloys, stainless steel alloys, or combinations thereof.

In yet another embodiment, each aluminum alloy of the aluminum alloys may include an aluminum-silicon (Al—Si) alloy, an aluminum-magnesium (Al—Mg) alloy, an aluminum-copper (Al—Cu) alloy, an aluminum-magnesium-silicon (Al—Mg—Si) alloy, an aluminum-zinc-(magnesium, copper) (Al—Zn—(Mg, Cu)0 alloy, or combinations thereof.

In still yet another embodiment, the base solution may include sodium hydroxide, potassium hydroxide, calcium hydroxide, magnesium hydroxide, lithium hydroxide, aluminum hydroxide, ammonium hydroxide, or combinations thereof.

In a further embodiment, in the performing the alkali treatment, the alkali treatment may be performed in the base solution having a concentration of 1-30 wt. % at a temperature of 30-70° C. for 20-240 seconds.

In another further embodiment, the acid solution may include hydrochloric acid, sulfuric acid, nitric acid, formic acid, hydrofluoric acid, acetic acid, or combinations thereof.

In still another further embodiment, in the performing the acid treatment, the acid treatment may be performed in the acid solution having a concentration of 1-20 wt. % at a temperature of 30-80° C. for 30-300 seconds.

In yet another further embodiment, A356 may be used as the metal. The alkali treatment may be performed in the base solution having a concentration of 2-10 wt. % at a temperature of 40-60° C. for 20-120 seconds. The acid treatment may be performed in the acid solution having a concentration of 2-10 wt. % at a temperature of 40-60° C. for 120-240 seconds, and the alkali treatment and the alkali treatment may be repeated 4 to 5 times.

In still yet another further embodiment, ADC12 may be used as the metal. The alkali treatment may be performed in the base solution having a concentration of 1.5-5 wt. % at a temperature of 40-60° C. for 20-120 seconds. The acid treatment may be performed in the acid solution having a concentration of 1.5-5 wt. % at a temperature of 40-60° C. for 20-120 seconds, and the alkali treatment and the alkali treatment may be repeated 3 to 4 times.

In a still further embodiment, A6061 may be used as the metal. The alkali treatment may be performed in the base solution having a concentration of 2-15 wt. % at a temperature of 40-70° C. for 60-180 seconds. The acid treatment may be performed in the acid solution having a concentration of 2-10 wt. % at a temperature of 40-70° C. for 60-300 seconds, and the alkali treatment and the alkali treatment may be repeated 2 to 3 times.

In a yet still further embodiment, the different materials may be the metal and a polymer resin.

Other aspects and embodiments of the disclosure are discussed infra.

### BRIEF DESCRIPTION OF THE DRAWINGS

The above and other features of the present disclosure are now described in detail with reference to certain exemplary embodiments thereof illustrated in the accompanying drawings, which are given hereinbelow by way of illustration only, and thus are not limitative of the present disclosure, and wherein:

FIG. 1 is a flowchart representing a chemical surface treatment method of a metal according to the present disclosure;

FIG. 2 is a schematic view showing the chemical surface treatment method according to the present disclosure;

FIGS. 3A, 3B and 3C are scanning electron microscope (SEM) images of a metal surface reformed by the chemical surface treatment method according to the present disclosure;

FIG. 4 shows characteristics of metal surfaces used in Examples;

FIG. 5, views (A)-(C), are schematic views representing a chemical surface treatment process of an A356 alloy;

FIG. 6, views (A)-(C), are schematic views representing a chemical surface treatment process of an ADC12 alloy;

FIG. 7, views (A)-(C), are schematic views representing a chemical surface treatment process of an A6061 alloy;

FIG. 8, views (A) and (B), are views showing specimens in which metals surface-treated by methods according to Examples are bonded to plastic;

FIGS. 9A and 9B are SEM images of the specimen in which the metal surface-treated by the method according to one Example is bonded to the plastic;

FIGS. 10A and 10B are optical images of the surfaces and the longitudinal-sections of the specimens in which the metals surface-treated by the methods according to the Examples are bonded to the plastic;

FIGS. 11A and 11B are SEM images of the metals surface-treated by the methods according to the Examples;

FIG. 12 shows SEM images of a metal surface-treated by the method according to the present disclosure depending on the number of repetitions of alkali treatment and acid treatment; and

FIGS. 13-15 show graphs representing measured values of surface roughness of the specimens in which the metals surface-treated by the methods according to the Examples are bonded to the plastic.

It should be understood that the appended drawings are not necessarily to scale, presenting a simplified representation of various features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

The above-described objects, other objects, advantages, and features of the present disclosure should become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the following description of the embodiments, the same elements are denoted by the same reference numerals even when they are depicted in different drawings. In the drawings, the dimensions of structures may be exaggerated compared to the actual dimensions thereof, for clarity of description. In the following description of the embodiments, terms, such as “first” and “second,” may be used to describe various elements but do not limit the elements. These terms are used only to distinguish one element from other elements. For example, a first element may be named a second element, and similarly, a second element may be named a first element, without departing from the scope and spirit of the disclosure. Singular expressions may encompass plural expressions unless they have clearly different contextual meanings.

In the following description of the embodiments, terms such as “including,” “comprising,” and “having” and variations thereof are to be interpreted as indicating the presence of characteristics, numbers, steps, operations, elements or parts stated in the description or combinations thereof. Such terms do not exclude the presence of one or more other characteristics, numbers, steps, operations, elements, parts or combinations thereof, or possibility of adding the same. In addition, it should be understood that, when a part, such as a layer, a film, a region, or a plate, is said to be “on” another part, the part may be located “directly on” the other part or other parts may be interposed between the two parts. In the same manner, it should be understood that, when a part, such as a layer, a film, a region, or a plate, is said to be “under” another part, the part may be located “directly under” the other part or other parts may be interposed between the two parts.

All numbers, values and/or expressions representing amounts of components, reaction conditions, polymer compositions, and blends used in the description are approximations in which various uncertainties in measurement generated when these values are acquired from different things are reflected. Thus, it should be understood that they are modified by the term “about,” unless stated otherwise. In addition, it should be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise.

The present disclosure relates to a chemical surface treatment method of a metal for improved bonding of different materials. Hereinafter, exemplary embodiments of the present disclosure are described in detail with reference to the accompanying drawings.

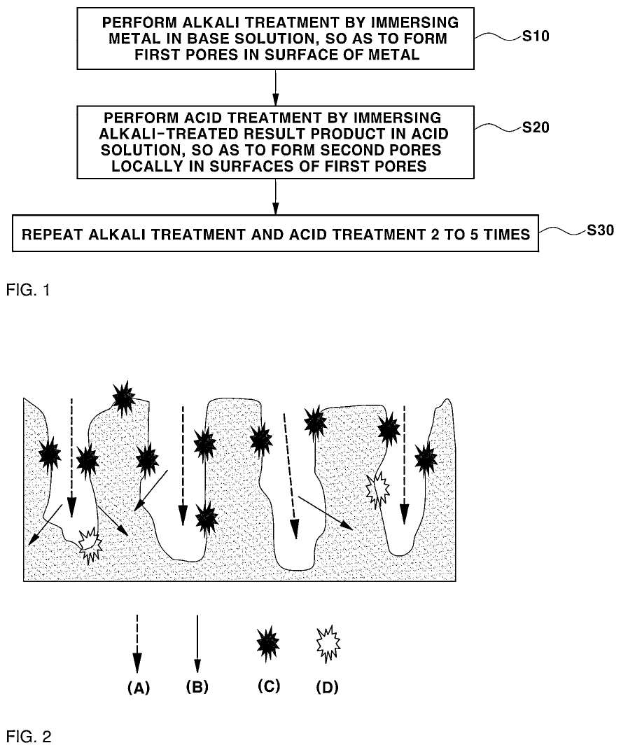

FIG. 1 is a flowchart representing a chemical surface treatment method of a metal according to the present disclosure. FIG. 2 is a schematic view showing the chemical surface treatment method according to the present disclosure.

Referring to these figures, the chemical surface treatment method according to the present disclosure includes: performing alkali treatment by immersing the metal in a base solution, so as to form first pores in the surface of the metal (S10); performing acid treatment by immersing an alkali-treated result product in an acid solution, so as to form second pores locally in the surfaces of the first pores (S20); and repeating the alkali treatment and the acid treatment 2 to 5 times (S30).

First, in Operation S10, the alkali treatment is performed by putting the metal into the base solution, thereby producing the alkali-treated result product.

The metal may include aluminum alloys, magnesium alloys, stainless steel alloys, or combinations thereof. Concretely, the aluminum alloy may include an Al—Si alloy, an Al—Mg alloy, an Al—Cu alloy, an Al—Mg—Si alloy, an Al—Zn—(Mg, Cu) alloy, or combinations thereof.

Here, the used base solution may include sodium hydroxide, potassium hydroxide, calcium hydroxide, magnesium hydroxide, lithium hydroxide, aluminum hydroxide, ammonium hydroxide, or combinations thereof.

Concretely, in the case of an aluminum alloy, sodium hydroxide is most effective as the base (alkali) solution in all stages. A metal oxide film may be very rapidly formed, and thus, a sodium hydroxide solution is used to easily remove an oxide.

The alkali treatment may be performed in the base solution having a concentration of 1-30 wt. % at a temperature of 30-70° C. for 20-240 seconds. However, the concentration of the base solution and the treatment temperature and time using the base solution in each stage are changed depending on characteristics of microstructures of a metal alloy composition.

As shown by direction (A) in FIG. 2, in Operation S10, the first pores are formed in the surface of the metal. Here, the first pores may be micro-sized pores.

In Operation S10, metal reactions by a base are described as follows, for example, using aluminum and a sodium hydroxide solution. When a general metal alloy is used, reactions similar to the following reactions occur.

2Al+2H₂O+2NaOH→2NaAlO₂+3H₂ (1)

Al₂O₃+3H₂O+2NaOH→2Na[Al(OH)₄] (2)

Reactivity to aluminum and aluminum oxide is very fast. Therefore, the micro-sized pores may be formed by etching, but, in the case in which a metal is not pure aluminum, regions of the surface of the metal near a eutectic phase are selectively etched, wherein such regions have high internal energy. Therefore, in a metal alloy, nano-sized etching is not performed.

The base solution has excellent reactivity to the metal and has a higher melting rate in weak regions of the surface of the metal, (e.g., regions of the surface of the metal having high internal energy), than other regions, thereby being capable of acquiring the micro-sized pores having a valley structure.

In the present disclosure, the structures of the pores generated, shown in directions (A) and (B) of FIG. 2, are referred to as “valley structures.”

Thereafter, in Operation S20, the acid treatment is performed by putting the result product acquired by the alkali treatment into the acid solution, thereby producing an acid-treated result product.

The acid solution may include hydrochloric acid, sulfuric acid, nitric acid, formic acid, hydrofluoric acid, acetic acid, or combinations thereof.

Concretely, in the case of an aluminum alloy, hydrochloric acid is most appropriate as the acid solution in all stages in terms of cost and reaction efficiency.

The acid treatment may be performed in the acid solution having a concentration of 1-20 wt. % at a temperature of 30-80° C. for 30-300 seconds, but the concentration of the acid solution and the treatment temperature and treatment time using the acid solution in each stage are changed depending on the characteristics of microstructures of the metal alloy composition. When the concentration of the acid solution exceeds 20 wt. %, the valley structures collapse, the acid solution is concentrated upon a specific region of the surface of the metal. Thus, surface corrosion (cubic form corrosion segregation) easily occurs, and it is difficult to acquire the uniform microscopic surface of the metal.

As shown by (C) in FIG. 2, in Operation S20, the second pores are formed locally in the surfaces of the first pores. Here, the second pores may be nano-sized pores.

In the present disclosure, the structures of the pores, as shown by (C) and (D) of FIG. 2, are referred to as “cubic structures”.

In Operation S20, metal reactions by an acid are described as follows, for example, using aluminum and a hydrochloric acid solution.

2Al+6HCl↔2AlCl₃+3H₂ (1)

2Al₂O₃+6HCl↔2AlCl₃+3H₂O (2)

A metal immersed in an acid cause multiple reactions, and concretely, the nano-sized cubic structures may be formed locally in the surfaces of the first pores by repetition of reactions, such as etching of aluminum, formation of an oxide film, re-etching, re-formation of the oxide film, etc.

The acid may react with intermetallic compounds, and simultaneously form nano-sized cubic etching structures in an oxidized aluminum surface layer.

Therefore, a surface layer formed by performing the alkali treatment and the acid treatment once exhibits locally etched effects, because the regions of the surface of the metal, which have high internal energy, near the eutectic phase may be etched. The reason for this is that only weak portions of the surface of the metal having high internal energy are rapidly etched.

Thereafter, in Operation S30, the alkali treatment and the acid treatment are repeated at least twice.

The number of repetitions of the alkali treatment and the acid treatment may be changed depending on the characteristics of microstructures of the metal alloy composition.

In the alkali treatment and the acid treatment, as the concentrations of the treatment solutions and the treatment temperatures and times increase, the melting amount of the metal increases. Therefore, the high concentration of the treatment solution, the high treatment temperature and the long treatment time cause a limit in formation of desired undercut shapes. It is easy to form a flat structure caused by collapse of undercuts rather than the undercuts through overall surface etching, and the amount of loss of the metal is increased.

Further, the low concentration of the treatment solution, the low treatment temperature, and the short treatment time cause a limit in the amount of reaction, and thus causes a limit in uniform etching of a plane.

Therefore, when the alkali treatment and the acid treatment are repeated, (e.g., 2 times, 3 times, etc.), the base solution intensifies the primarily formed valley structures at corrosion rates different from that of the primarily performed alkali treatment and etches other regions of the metal layer having high internal energy. The valley structures are thereby intensified throughout the surface of the metal in direction (B) of FIG. 2.

In the same manner, when the alkali treatment and the acid treatment are repeated, (e.g., 2 times, 3 times, etc.), the acid solution increases formation of the cubic structures near the valley structures, as shown by (D) of FIG. 2.

Therefore, the undercut shapes may be intensified through repeated etching using the base solution and the acid solution, and further, three-dimensional cave structures may be implemented.

In the present disclosure, all pores formed in the surface of the metal, as shown by (A) and (C) of FIG. 2, are referred to as “undercuts.”

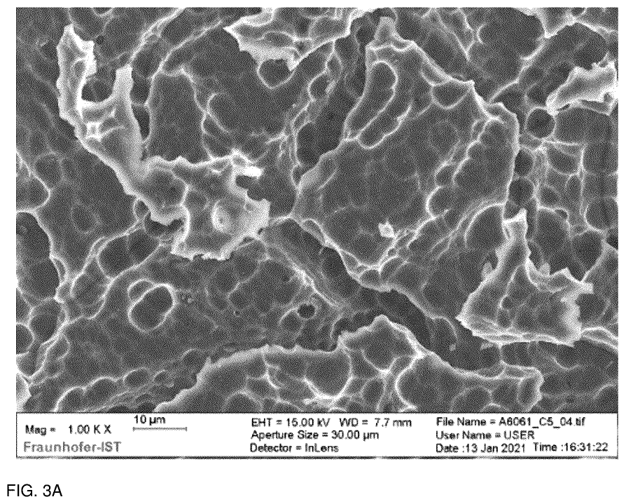

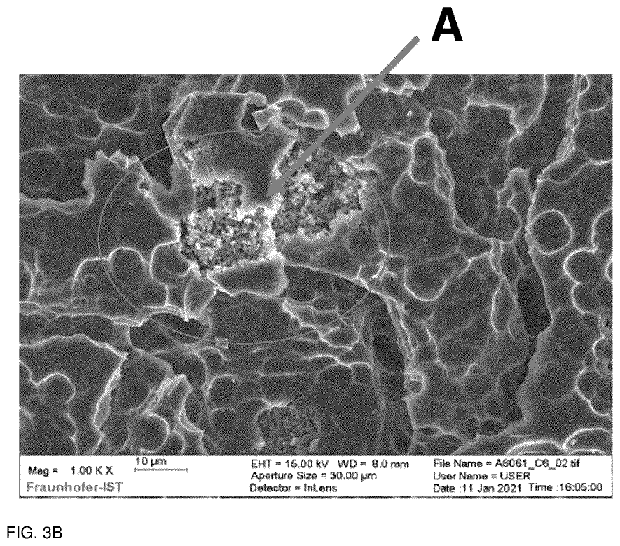

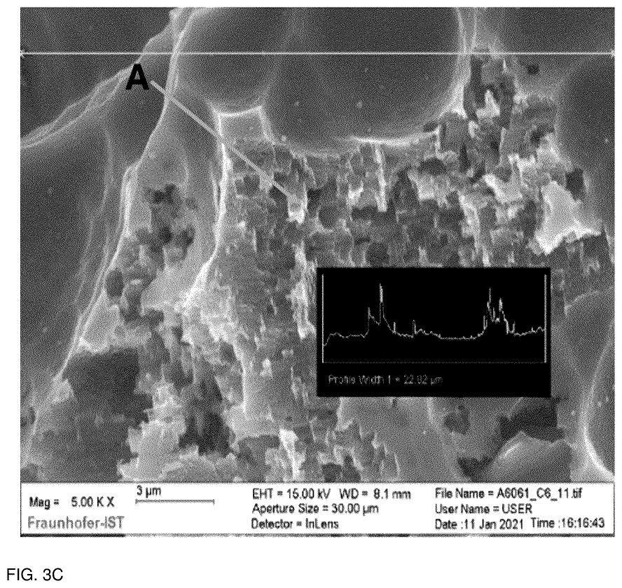

FIGS. 3A, 3B, and 3C are scanning electron microscope (SEM) images of a metal surface reformed by the chemical surface treatment method according to the present disclosure.

As shown in FIG. 3A, in the chemical surface treatment method according to the present disclosure, micro-sized pores may be uniformly formed in the surface of the metal.

Further, as shown in FIG. 3B, in the chemical surface treatment method according to the present disclosure, nano-sized pores may be uniformly formed locally in the surfaces of the micro-sized pores.

FIG. 3C is an enlarged image of a portion A, (e.g., a micro-sized pore), shown in FIG. 3B.

Process ranges in consideration of reactivity are important, and the process ranges depending on a respective metal alloy are as follows.

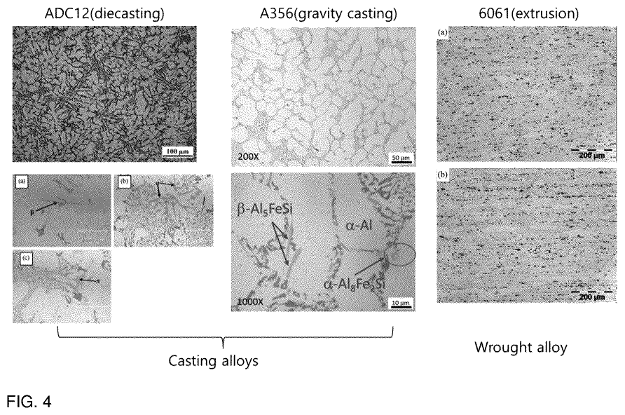

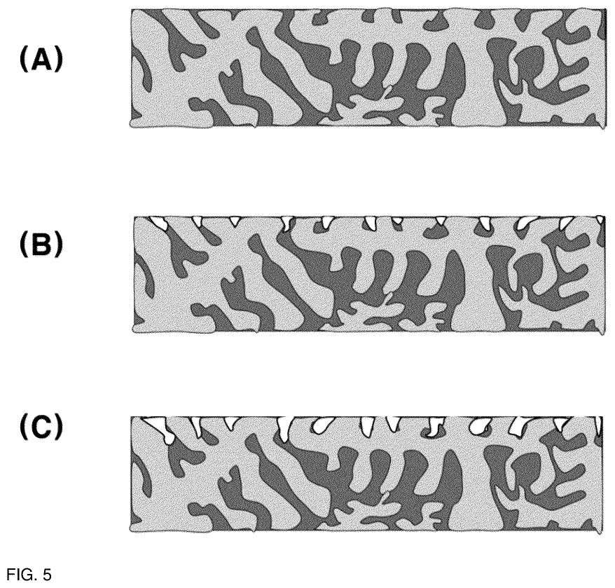

Metals used in the present disclosure are A356, ADC12, and A6061 alloys. Referring to FIG. 4, the respective metals exhibit the following characteristics. FIG. 4 shows characteristics of metal surfaces used in Examples.

In the present disclosure, the A356 alloy may be used as the metal alloy. When the A356 alloy is used, the alkali treatment may be performed in the base solution having a concentration of 2-10 wt. % at a temperature of 40-60° C. for 20-120 seconds. Further, the acid treatment may be performed in the acid solution having a concentration of 2-10 wt. % at a temperature of 40-60° C. for 120-240 seconds. Also, the alkali treatment and the acid treatment may be repeated 4 to 5 times using the sodium hydroxide solution and the hydrochloric acid solution.

Here, etching in each stage may be performed so that an etching degree is gradually reduced after the alkali treatment and the acid treatment have been repeated 3 times, and 120 seconds are appropriate as an etching time in each stage.

When the concentration of the sodium hydroxide solution exceeds 10 wt. % or the concentration of the hydrochloric acid solution exceeds 10 wt. %, local corrosion effects are increased, and thus, it is difficult to acquire overall uniform microstructures.

Further, when the alkali treatment and the acid treatment exceed the temperature and time conditions of the above-described ranges in the present disclosure, uniformity in the microstructures may be reduced.

The A356 alloy has clear dendritic structures, and there is a limit to change of aluminum structures near dendrites through 2 to 3 repetitions of the alkali treatment and the acid treatment. Therefore, in order to firmly form valley structures, the alkali treatment and the acid treatment need to be repeated more than 3 times. Also, maximization of formation of cubic structures is maintained under conditions in which the alkali treatment and the acid treatment are repeated 4 times.

Further, when the alkali treatment and the acid treatment are repeated more than 5 times, the valley structures may collapse.

Referring to FIG. 5, views (A)-(C), the A356 alloy had typical dendritic structures (due to low pressure die-casting) in a state before etching (in FIG. 5, view (A)). Only regions of the A356 alloy in the eutectic phase were etched at nonuniform positions in a state after the alkali treatment and the acid treatment have been performed once (in FIG. 5, view (B)). Also, uniform undercuts in the microstructures were formed through repetition of the alkali treatment and the acid treatment in a state after the alkali treatment and the acid treatment have been performed 2 to 5 times (in FIG. 5, view (C)). Here, FIG. 5, views (A)-(C) are schematic views representing a chemical surface treatment process of the A356 alloy according to the present disclosure.

Further, in the present disclosure, the ADC12 alloy may be used as the metal alloy. When the ADC12 alloy is used, the alkali treatment may be performed in the base solution having a concentration of 1.5-5 wt. % at a temperature of 40-60° C. for seconds. Further, the acid treatment may be performed in an acid solution having a concentration of 1.5-5 wt. % at a temperature of 40-60° C. for 20-120 seconds. Also, the alkali treatment and the acid treatment may be repeated 3 to 4 times using the sodium hydroxide solution and the hydrochloric acid solution.

Here, etching in each stage may be performed so that an etching degree is gradually reduced after the alkali treatment and the acid treatment have been repeated 2 times. Also, 20-120 seconds are appropriate as an etching time in each stage because the ADC12 alloy has a great amount of solute (e.g., a eutectic composition).

Further, in the ADC12 alloy having the great amount of the solute, when the concentration of the base solution exceeds 10 wt. %, it may be difficult to control etching due to generation of a large amount of etching by-products. Also, the surface of the ADC12 alloy may be flattened without formation of valley structures due to a high reaction rate. When the concentration of the base solution is equal to or less than 1 wt. %, it is difficult to acquire valley-shaped microstructures. The reason for this is that the ADC12 alloy has a composition with very high reactivity and is a eutectic structure as a whole, and thus reacts with chemical etching.

Therefore, the ADC12 alloy may acquire the highest strength of bonding force under low concentration and etching degree conditions.

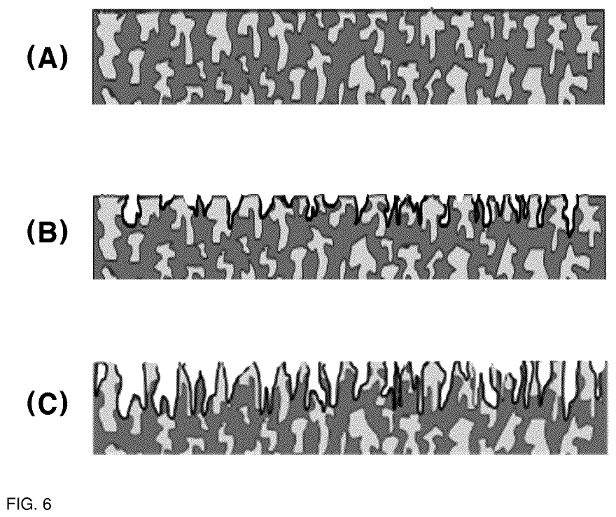

Referring to FIG. 6, views (A)-(C), the ADC12 alloy had a small fraction of a primary phase and a large fraction of a eutectic phase (due to die-casting) in a state before etching (in FIG. 6, view (A)). The ADC12 alloy exhibited small and nonuniform depths of pores due to a relatively high reaction rate in a state after the alkali treatment and the acid treatment have been performed once (in FIG. 6, view (B)). The ADC alloy exhibits deep undercuts formed at regions near the eutectic phase in a state after the alkali treatment and the acid treatment have been performed 2 to 5 times (in FIG. 6, view (C)). Further, primary aluminum was etched, and thus, nanocubic structures were uniformly produced. Here, FIG. 6, views (A)-(C) are schematic views representing a chemical surface treatment process of the ADC12 alloy according to the present disclosure.

Further, in the present disclosure, the A6061 alloy may be used as the metal alloy. When the A6061 alloy is used, the alkali treatment may be performed in the base solution having a concentration of 2-15 wt. % at a temperature of 40-70° C. for 60-180 seconds. Further, the acid treatment may be performed in the acid solution having a concentration of 2-10 wt. % at a temperature of 40-70° C. for 60-300 seconds. Also, the alkali treatment and the acid treatment may be repeated 2 to 3 times using the sodium hydroxide solution and the hydrochloric acid solution.

Here, etching in each stage may be performed so that an etching degree is gradually reduced so as not to collapse valley structures which were initially formed.

The A6061 alloy has few eutectic structures in terms of the composition thereof and is configured such that grain boundaries may be etched, and thus the A6061 alloy should be etched at an etching degree which is higher than the A356 alloy and is lower than the ADC12 alloy, in most repeated etching sections.

In the A6061 alloy, when the alkali treatment and the acid treatment are performed 4 times or more, the valley structures collapse or nanocubic structures are segregated. Therefore, the alkali treatment and the acid treatment may not be repeated 4 times or more.

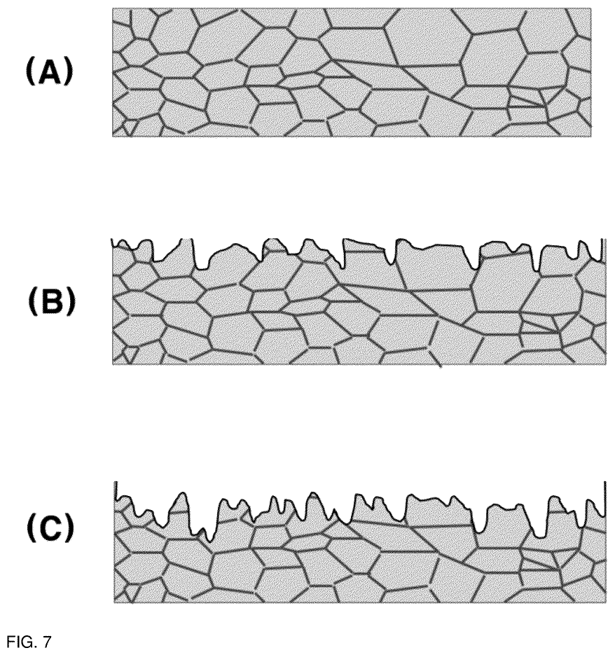

Referring to FIG. 7, views (A)-(C), the A6061 alloy had a typical wrought alloy structure in a state before etching (in FIG. 7, view (A)). The A6061 alloy had an uneven surface due to valleys formed by reactions and exhibited nanocubic structures nonuniformly formed in the surface in a state after the alkali treatment and the acid treatment have been performed once (in FIG. 7, view (B)). The A6061 alloy exhibited uniform microvalley-shaped undercuts formed in the surface due to progress in etching in a state after the alkali treatment and the acid treatment have been performed 2 to 5 times (in FIG. 7, view (C)). Further, maximization of roughness of the surface and uniformization of the nanocubic structures may be achieved through repetition of the alkali treatment and the acid treatment. Here, FIG. 7, views (A)-(C) are schematic views representing a chemical surface treatment process of the A6061 alloy according to the present disclosure.

Therefore, in the present disclosure, the alkali treatment and the acid treatment may be repeated 2 to 5 times depending on the characteristics of the microstructures of the metal so as to acquire optimal shapes.

Further, different materials used in the chemical surface treatment method of the metal according to the present disclosure are not limited to specific materials, and concretely, may include the metal and a polymer resin. Further, the present disclosure may be applied to various fields without being limited thereto and may be applied to bonding of vehicle parts formed of various materials so as to achieve weight lightening and cost reduction.

The polymer resin may be bonded to the metal in a molten state, and anodic reactions and cathodic reactions on the molten surface of the metal are the same as the reactions in a general etching solution. However, a reaction rate may vary depending on the concentration of the polymer resin, a reaction temperature, etc. The reactions on the molten surface of the metal are as follows.

(1) Anodic Reactions (Dissolution)

Al↔Al³⁺+3e⁻; or

Mg↔Mg²⁺+2e⁻; or

Fe↔Fe²⁺+2e⁻; or

Si↔Si⁴⁺+4e⁻; or

Cu↔Cu²⁺+4e⁻

(2) Cathodic reactions (reduction)

2H⁺+2e⁻↔H₂; or

O₂±2H₂O+4e⁻↔4OH⁻

(3) Reaction of ‘Smut’

CuO,Cu(OH)₂,SiO₂,Si(OH)₄,Fe₂O₃,etc.

Hereinafter, the present disclosure is described in more detail through the following examples. The following examples serve merely to exemplarily describe the present disclosure and are not intended to limit the scope of the disclosure.

### Example 1 (Aluminum Alloy for Gravity Casting, A356)

In Example 1, an A356 alloy was used as a metal alloy. Alkali treatment was performed in a base solution having a concentration of 2-10 wt. % at a temperature of ° C. for 20-120 seconds. Acid treatment was performed in an acid solution having a concentration of 2-10 wt. % at a temperature of 40-60° C. for 120-240 seconds. The alkali treatment and the acid treatment were repeated 4 to 5 times so as to reform the surface of the metal alloy.

The A356 alloy used in Example 1 is an aluminum alloy including components set forth in Table 1.

TABLE 1

| | | | | | | | Mg |
|---|---|---|---|---|---|---|---|
| Si [%] | Al [%] | Mn [%] | Ti [%] | Fe [%] | Zn [%] | Cu [%] | [%] |
| 6.5-7.5 | 0 ≥ 80 | 0 ≤ 0.1 | 0 ≤ 0.2 | 0 ≤ 0.2 | 0 ≤ 0.1 | 0 ≤ 0.2 | 0.25- |
| | | | | | | | 0.45 |

A356 (casting alloy, AlSi₇Mg): Primary phase regions are very large, and an Al—Si eutectic phase and intermetallic compounds exist in dark gray regions.

### Example 2 (Aluminum Alloy for Die-Casting, ADC12)

In Example 2, an ADC12 alloy was used as a metal alloy. Alkali treatment was performed in a base solution having a concentration of 1.5-5 wt. % at a temperature of 40-60° C. for 20-120 seconds. Acid treatment was performed in an acid solution having a concentration of 1.5-5 wt. % at a temperature of 40-60° C. for 20-120 seconds. The alkali treatment and the acid treatment were repeated 3 to 4 times so as to reform the surface of the metal alloy.

The ADC12 alloy used in Example 2 is an aluminum alloy including components set forth in Table 2.

TABLE 2

| | | | | | | | Mg |
|---|---|---|---|---|---|---|---|
| Si [%] | Al [%] | Mn [%] | Fe [%] | Ni [%] | Zn [%] | Cu [%] | [%] |
| 9.6-12 | 0 ≥ 80 | 0 ≤ 0.5 | 0 ≤ 1.3 | 0-0.5 | 0 ≤ 1 | 1.5-3.5 | 0 ≤ |
| | | | | | | | 0.3 |

ADC12 (casting alloy, AlSi₁₂Cu₃Mg): Many eutectic phase regions are distributed (in black regions), most of these regions are in an Al—Si eutectic phase, and a large number of intermetallic compounds formed by Fe, Cu and Mg exist.

### Example 3 (Wrought Alloy, A6061)

In Example 3, an A6061 alloy was used. Alkali treatment was performed in a base solution having a concentration of 2-15 wt. % at a temperature of 40-70° C. for 60-180 seconds. Acid treatment was performed in an acid solution having a concentration of 2-10 wt. % at a temperature of 40-70° C. for 60-300 seconds. The alkali treatment and the acid treatment were repeated 2 to 3 times so as to reform the surface of the metal alloy.

The A6061 alloy used in Example 3 is an aluminum alloy including components set forth in Table 3.

TABLE 3

| | | | | | | | Mg |
|---|---|---|---|---|---|---|---|
| Si [%] | Mn [%] | Ti [%] | Cr [%] | Fe [%] | Zn [%] | Cu [%] | [%] |
| 0.4-0.8 | 0 ≤ 0.15 | 0 ≤ 0.15 | 0.04- | 0 ≤ 0.7 | 0 ≤ 0.25 | 0.15- | 0.8- |
| | | | 0.35 | | | 0.4 | 1.2 |

A6061 (wrought alloy/extruded alloy, AlSiMg): The amount of solute is very small, aluminum is divided into small grains, and black particles are Mg₂Si acting as a strengthening mechanism.

Thereafter, bonding properties between different materials were evaluated through optical analysis and by measuring surface roughness.

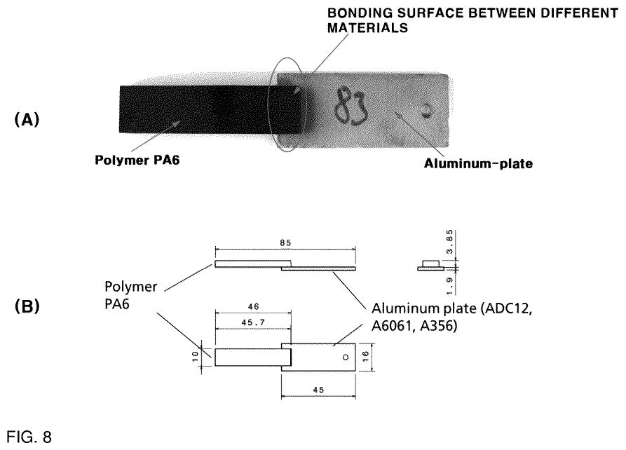

FIG. 8, views (A) and (B) are views showing specimens in which metals surface-treated by methods according to Examples are bonded to plastic. First, in order to perform evaluation, the specimens for shear tests were manufactured using the surface-treated metals according to Examples 1 to 3. The specimens may be acquired in a way where a molten resin is injected onto an aluminum plate inserted into a mold. Most general plastic resins may be used, and a molten metal may be inserted into the mold. In the present disclosure, PA6-GF60, which is a general resin for vehicles, was used.

### Optical and SEM Analyses

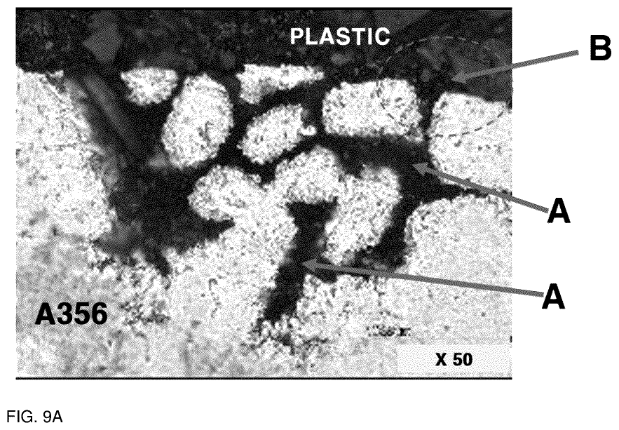

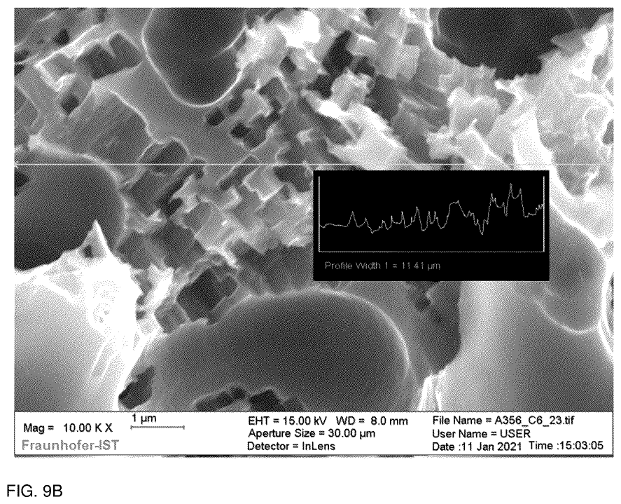

FIGS. 9A and 9B are SEM images of the specimen in which the metal surface-treated by the method according to Example 1 is bonded to the plastic. Referring to FIG. 9A, it may be confirmed that micro-sized undercuts were formed, as shown in regions A, and a nano-sized cubic undercut was formed locally in the micro-sized undercut, as shown in region B.

FIG. 9B is an enlarged view of region B of FIG. 9A, and it may be confirmed that the nano-sized cubic undercuts were formed in the micro-sized undercut.

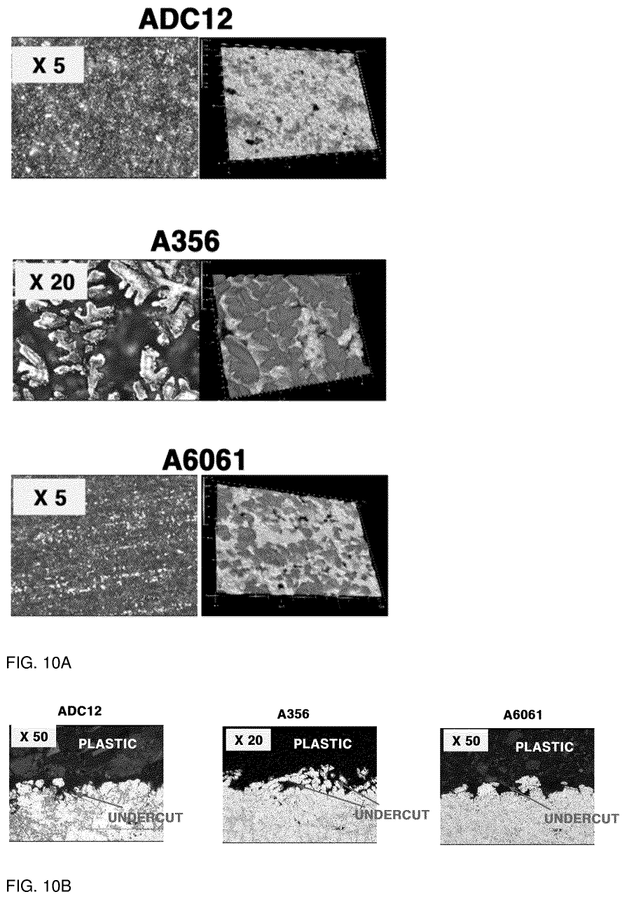

FIGS. 10A and 10B are optical images of the surfaces and the longitudinal-sections of the specimens in which the metals surface-treated by the methods according to Examples 1 to 3 are bonded to the plastic.

FIG. 10A shows the etched surfaces of the specimens and FIG. 10B shows the longitudinal-sections of the specimens.

Referring to FIGS. 10A and 10B, it may be confirmed that micro-sized undercuts were formed all over the surfaces of the specimens, and nano-sized undercuts were formed locally in the micro-sized undercuts.

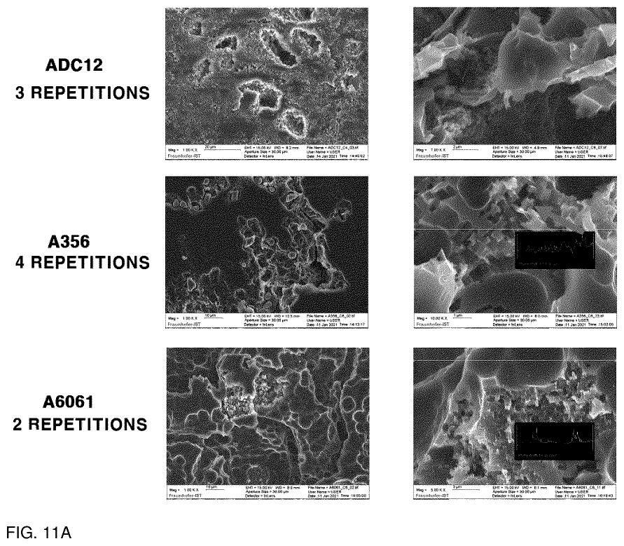

FIGS. 11A and 11B are SEM images of the metals surface-treated by repeating the alkali treatment and the acid treatment a specific number of times according to Examples 1-3.

Referring to FIG. 11A, it may be confirmed that, by repeating the alkali treatment and the acid treatment a specific number of times according to Examples 1 to 3, the micro-sized undercuts were formed, as shown in region A, and the nano-sized undercuts were formed locally in the micro-sized undercuts, as shown in region B.

FIG. 11B is an optical image of the metal surface-treated by repeating the alkali treatment and the acid treatment 3 times and shows maximized surface roughness due to valley structures formed all over the surface of the metal, and nano-sized cubic undercuts formed locally in the valley structures, as compared to FIG. 11A.

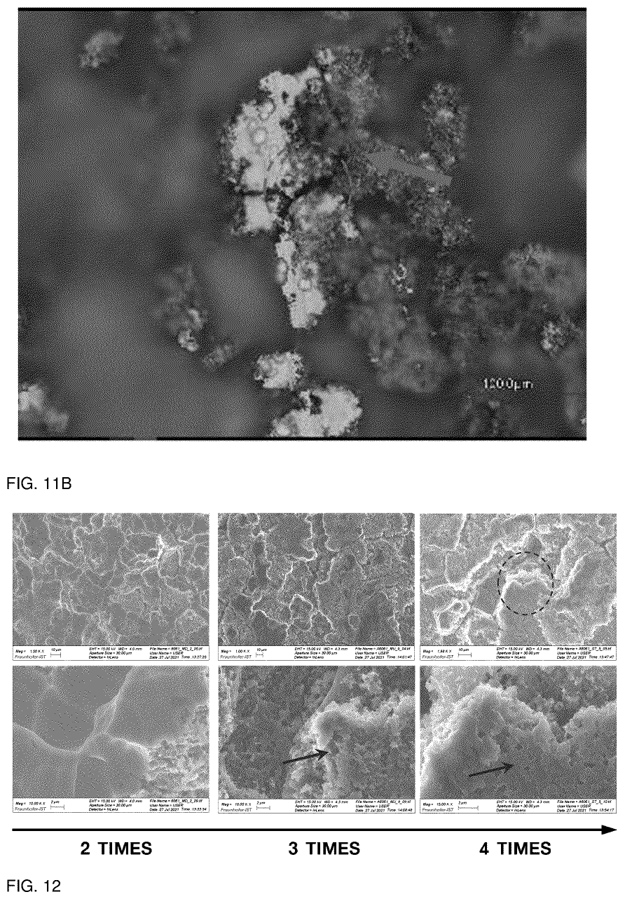

FIG. 12 shows SEM images of the metal surface-treated by the method according to Example 1 depending on the number of repetitions of the alkali treatment and the acid treatment.

Referring to FIG. 12, as results of repetitions of the alkali treatment and the acid treatment performed on the A6061 alloy two times, three times and four times, respectively, it may be confirmed that a high and uniform bonding property value is acquired when the alkali treatment and the acid treatment were performed two times or three times.

When the alkali treatment and the acid treatment were performed on the A6061 alloy four times, the valley-shaped structures collapse or the amount of loss of the metal is increased due to addition of a large number of etching processes, and thus, dimensional instability may occur.

Therefore, in the present disclosure, conditions for maximally forming the optimum valley structures and nano-sized cubic structures are confirmed through proper numbers of repetitions of the alkali treatment and the acid treatment according to the Examples.

### Surface Roughness Evaluation

Surface roughness is an evaluation index acquired by numerical analysis and differential and integral calculus of the entirety of a surface and is used to accurately detect the characteristics of the entirety of the surface, as compared to line roughness based on single line analysis.

The present disclosure relates to reformation of a bonding surface through chemical surface treatment. Thus, surface roughness may be measured as the evaluation index, and, in the present disclosure, the surface characteristics of the specimens were confirmed by measuring the mean values of 10 samples as Sa, Sz, and Sdr values of the corresponding specimens.
Sz: Maximum height
Sa: Arithmetical mean height
Sdr: Developed interfacial area ratio

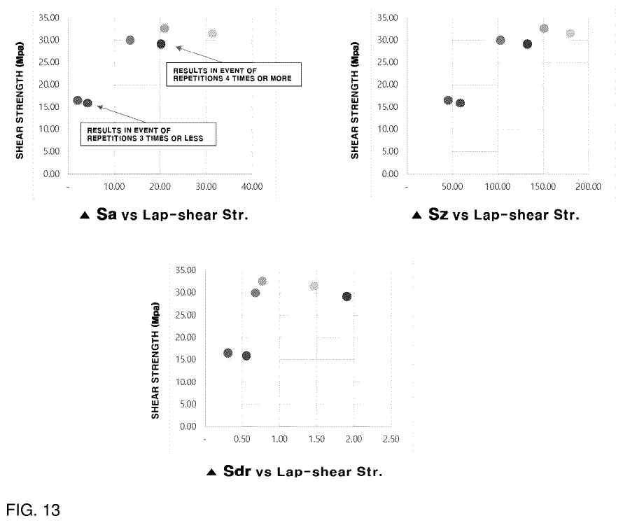

FIG. 13 shows graphs representing measured values of surface roughness of the specimen in which the A356 alloy surface-treated by the method according to Example 1 is bonded to the plastic.

Referring to FIG. 13, the A356 alloy may acquire a property value up to 34 MPa at maximum.

Concretely, when the alkali treatment and the acid treatment are repeated 3 times or less, the A356 alloy may acquire very low roughness and a shear strength of 16 MPa. On the contrary, when the alkali treatment and the acid treatment are repeated 4 times or more, the A356 alloy may acquire increased roughness and a shear strength of 34 MPa at maximum.

Therefore, the A356 alloy may acquire a shear strength of 34 MPa at maximum within ranges of Sa of 3-35 micrometers (μm), Sz of 45-190 μm, and Sdr of 0.2-2.0.

Particularly, the A356 alloy may acquire the most stable and best properties within ranges of Sa of 10 μm or more, Sz of 100 μm or more, and Sdr of 0.6-1.6.

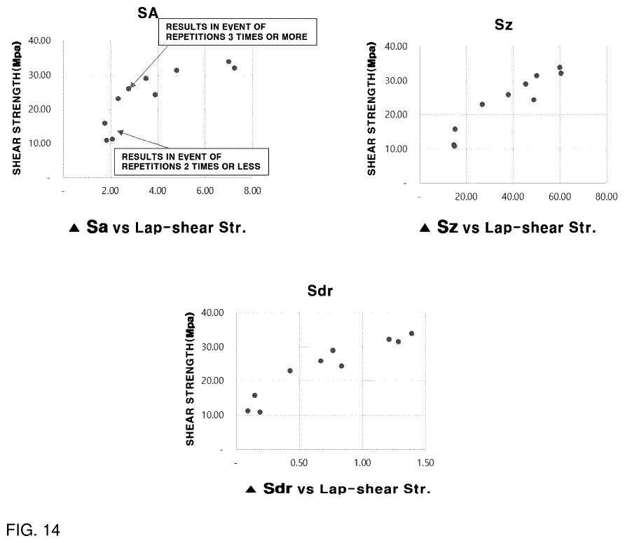

FIG. 14 shows graphs representing measured values of surface roughness of the specimen in which the ADC12 alloy surface-treated by the method according to Example 2 is bonded to the plastic.

Referring to FIG. 14, the ADC12 alloy may acquire a property value up to 35 MPa at maximum.

Concretely, the ADC12 alloy is sensitive to etching conditions, and thus, two-stage undercuts should be formed by performing etching 3 to 4 steps. The surface roughness of the ADC12 alloy is rapidly increased when third etching is performed. Thus, the ADC12 alloy may acquire a shear strength of 35 MPa at maximum when the alkali treatment and the acid treatment are repeated 4 times.

Further, the ADC12 alloy may acquire a shear strength of 35 MPa at maximum within ranges of Sa of 2-4 μm, Sz of 25-55 μm, and Sdr of 0.4-0.9.

The ADC12 alloy may acquire the most stable and best properties within ranges of Sa of 2-3.5 μm, Sz of 25-45 μm, and Sdr of 0.4-0.8. In the ADC12 alloy, when overetching is performed or the alkali treatment and the acid treatment are repeated, the ADC12 alloy has reverse effects on properties thereof due to contamination by smut. Concretely, the valley structures formed in the surface of the metal may be reduced, and a bonding property value of 10 MPa or more may not be acquired due to by-products, such as the smut.

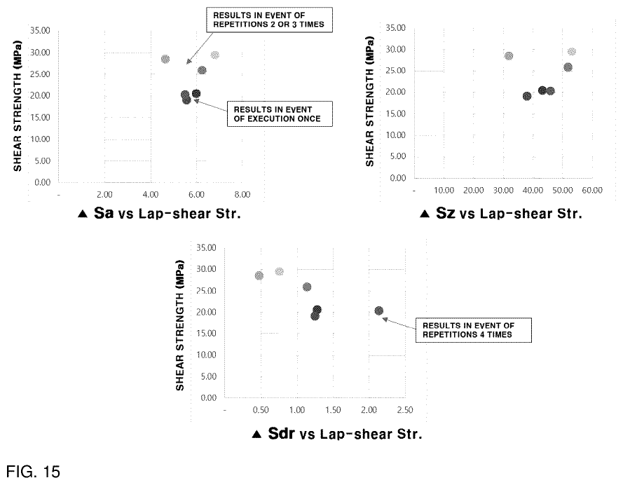

FIG. 15 shows graphs representing measured values of surface roughness of the specimen in which the A6061 alloy surface-treated by the method according to Example 3 is bonded to the plastic.

Referring to FIG. 15, the A6061 alloy may acquire a property value up to 33 MPa at maximum.

Concretely, when the alkali treatment and the acid treatment are performed once, the A6061 alloy may acquire insufficient roughness, and particularly, may have acquire a shear strength of 20 MPa due to occurrence of restriction on formation of nanocubic structures.

When the alkali treatment and the acid treatment are repeated 2 to 3 times, the A6061 alloy may have nanocubic structures through sufficient treatment using HCl and may thus acquire improved properties.

Further, the A6061 alloy may acquire a shear strength of 33 MPa at maximum within ranges of Sa of 4-8 μm, Sz of 30-55 μm, and Sdr of 0.3-2.5.

Particularly, the A6061 alloy may acquire the most stable and best properties within ranges of Sa of 6 μm or more, Sz of 50 μm or more, and Sdr of 0.5-1.5.

Because the A6061 alloy has a very small amount of intermetallic compounds, when the HCl treatment is sufficiently performed even though the rate of Sa/Sz is not high, properties of the A6061 alloy may be improved under a low Sdr condition.

In the A6061 alloy, valley structures are important, and particularly, properties of the A6061 alloy may be improved by nano-sized surface treatment, in contrast to other alloys for casting. Because the A6061 alloy has a small amount of solute, the A6061 alloy may exhibit high strength even when the alkali treatment and the acid treatment are repeated 2 times but may exhibit low strength when the alkali treatment and the acid treatment are repeated 4 times. On the other hand, when the alkali treatment and the acid treatment are performed once, uniformity in valley structures is reduced, nanocubic structures are formed at a low density, and thus, properties of the A6061 alloy are reduced.

Therefore, the present disclosure provides the structure of a metal to which molten plastic may be firmly bonded in bonding between the metal and the plastic, and, in the present disclosure, bonding properties may be improved by 100% or more as compared to an etching process performed once.

In reactions by acids and bases, regions of the surface of a metal near a eutectic phase, which have high internal energy, may react first. Therefore, desired microstructures (undercut-shaped structures), which are uniformly disposed throughout the whole area of the metal, may not be acquired by performing the alkali treatment and the acid treatment once.

Therefore, in the present disclosure, undercuts having a valley-shaped structure may be primarily formed by deeply etching phase boundary structures of a metal using a base solution. Nano-sized nanocubic structures may be secondarily formed through reactions between the metal and an acid, based on microstructural characteristics (a eutectic phase, a primary phase, intermetallic compounds, etc.) and reactivity differences between base solutions and acid solutions.

Further, according to the chemical surface treatment method of the metal for improved bonding of different materials according to the present disclosure, the optimized shapes of microstructures may be uniformly acquired using the alkali treatment and the acid treatment which are repeated two times or more.

As should be apparent from the above description, in a chemical surface treatment method of a metal according to the present disclosure, micro-sized pores may be formed in the surface of the metal, and nano-sized pores may be formed locally in the surfaces of the micro-sized pores, by repeating a pair of alkali treatment and acid treatment two times or more depending on microstructural characteristics (a eutectic phase, a primary phase, intermetallic compounds, etc.) of the metal.

Further, the chemical surface treatment method according to the present disclosure may increase bonding properties when a different material, such as molten plastic, is bonded to the reformed surface of the metal.

In addition, the chemical surface treatment method according to the present disclosure uses only an etching process based on solutions as a surface reforming method of the metal so as to increase bonding properties, thereby being capable of reducing process costs.

The technical concepts of the disclosure have been described in detail with reference to various embodiments. However, it should be appreciated by those having ordinary skill in the art that changes may be made in these embodiments without departing from the principles and spirit of the disclosure, the scope of which is defined in the appended claims and their equivalents.

What is claimed is:

1. A chemical surface treatment method of a metal, the method comprising:
performing an alkali treatment by immersing the metal in a base solution, so as to form first pores in a surface of the metal; and
performing an acid treatment by immersing an alkali-treated result product in an acid solution, so as to form second pores locally in surfaces of the first pores.

2. The method of claim 1, further comprising:
repeating the alkali treatment and the acid treatment 2 to 5 times, after an initial performing of the acid treatment.

3. The method of claim 1, wherein the first pores are micro-sized pores, and
wherein the second pores are nano-sized pores.

4. The method of claim 1, wherein the metal comprises aluminum alloys, magnesium alloys, stainless steel alloys, or any combination thereof.

5. The method of claim 4, wherein each aluminum alloy of the aluminum alloys comprises an Al—Si alloy, an Al—Mg alloy, an Al—Cu alloy, an Al—Mg—Si alloy, an Al—Zn—(Mg, Cu) alloy, or any combination thereof.

6. The method of claim 1, wherein the base solution comprises sodium hydroxide, potassium hydroxide, calcium hydroxide, magnesium hydroxide, lithium hydroxide, aluminum hydroxide, ammonium hydroxide, or any combination thereof.

7. The method of claim 1, wherein the alkali treatment is performed in the base solution having a concentration in a range of 1-30 wt. % at a temperature in a range of 30-70° C. for 20-240 seconds.

8. The method of claim 1, wherein the acid solution comprises hydrochloric acid, sulfuric acid, nitric acid, formic acid, hydrofluoric acid, acetic acid, or any combination thereof.

9. The method of claim 1, wherein the acid treatment is performed in the acid solution having a concentration in a range of 1-20 wt. % at a temperature in a range of 30-80° C. for 30-300 seconds.

10. The method of claim 1, wherein A356 is used as the metal,
wherein the alkali treatment is performed in the base solution having a concentration in a range of 2-10 wt. % at a temperature in a range of 40-60° C. for 20-120 seconds,
wherein the acid treatment is performed in the acid solution having a concentration in a range of 2-10 wt. % at a temperature in a range of 40-60° C. for 120-240 seconds, and
wherein the alkali treatment and the alkali treatment are repeated 4 to 5 times.

11. The method of claim 1, wherein ADC12 is used as the metal,
wherein the alkali treatment is performed in the base solution having a concentration in a range of 1.5-5 wt. % at a temperature in a range of 40-60° C. for 20-120 seconds,
wherein the acid treatment is performed in the acid solution having a concentration in a range of 1.5-5 wt. % at a temperature in a range of 40-60° C. for 20-120 seconds, and
wherein the alkali treatment and the alkali treatment are repeated 3 to 4 times.

12. The method of claim 1, wherein A6061 is used as the metal,
wherein the alkali treatment is performed in the base solution having a concentration in a range of 2-15 wt. % at a temperature in a range of 40-70° C. for 60-180 seconds;
wherein the acid treatment is performed in the acid solution having a concentration in a range of 2-10 wt. % at a temperature in a range of 40-70° C. for 60-300 seconds; and
wherein the alkali treatment and the alkali treatment are repeated 2 to 3 times.

13. The method of claim 1, further comprising:
bonding the alkali-treated and acid-treated metal with a polymer resin.
